(19) United States
(12) Patent Application Publication
(10) Pub. No.: US 2016/0062476 A1
(43) Pub. Date: Mar. 3, 2016

(54) Computer Keyboard Mouse

(71) Applicant: Terrance Holliday, Houston, TX (US)

(72) Inventor: Terrance Holliday, Houston, TX (US)

(21) Appl. No.: 14/605,359

(22) Filed: Jan. 26, 2015

Related U.S. Application Data
(60) Provisional application No. 61/945,872, filed on Feb. 28, 2014.

(51) Int. Cl. G06F 3/02; G06F 3/0354

(52) U.S. Cl. CPC G06F 3/0213; G06F 3/03543

(57) ABSTRACT

A computer keyboard mouse system for improved data entry is provided. The computer keyboard mouse system includes a housing. The housing includes a first top portion and a second top portion. A motion sensing relay device may be integrally attached to the housing. The motion sensing relay device inputs graphical location data to a graphical interface. At least two pointer select buttons may be disposed on the first top portion of the housing. The pointer select button is operative for selecting graphical objects on the graphical interface. A data entry portion is disposed on the second top portion of the housing. The data entry portion includes a plurality of keys. The data entry portion is operative for inputting data, such as numbers or letters, to the graphical interface.

### CROSS REFERENCE TO RELATED APPLICATION

This application claims the benefit of U.S. Provisional Application No. 61/945,872 filed on Feb. 28, 2014. The above identified patent application is herein incorporated by reference in its entirety to provide continuity of disclosure.

### FIELD OF THE INVENTION

The present invention generally relates to a computer mouse. More particularly, the present invention relates to a computer mouse with an integrated keyboard on the mouse housing.

### BACKGROUND OF THE INVENTION

Computers generally have the capability to receive input data representing numerical entries and the location of a cursor or other graphical objects on a graphical display. Graphical location data is conventionally entered into a computer using a mouse detached from a keyboard or, where space is limited as it is with portable laptop or notebook computers, by using four cursor arrow keys or a trackball built into the keyboard. Numerical data, on the other hand, is conventionally entered into a computer utilizing an array of ten keys arranged either in a single row across the top of a keyboard, or in four rows as a numerical keypad detached from, or at one end of, a keyboard. Such a numerical keypad is not often used with portable computers because of space limitations.

A mouse is generally preferred over cursor keys because a mouse facilitates simpler, faster, and more precise entry of graphical location data into a computer. A mouse is therefore commonly connected to an input/output (I/O) port of a portable computer to supplement cursor keys and, if one is provided, a trackball. However, portable computers generally have a limited number of I/O ports and when a mouse is connected to an I/O port, there is often not another port available for a device such as a numerical keypad.

When using a computer, individuals typically must utilize both a keyboard and a mouse in tandem. Thus, a person must constantly switch back and forth between operating the mouse and typing on the keyboard. This is particularly true where the user is entering data or numbers into a spreadsheet. Additionally, users may switch back and forth between the mouse and keyboard when completing homework or simply navigating their device. Frequently switching back and forth can decrease efficiency and may result in entry errors.

For this reason, and the additional important reason that users of portable computers are generally interested in conserving space, numerical keypads are not often used with portable computers. Nevertheless, a numerical keypad would simplify the entry of numerical data and also reduce the time required to make such entries.

For the foregoing reasons, there is a need to be able to input to a portable computer both graphical location data as well as numerical data via a single port of a portable computer without using a large amount of space.

### SUMMARY OF THE INVENTION

In view of the foregoing disadvantages inherent in the known types of data entry devices now present in the prior art, the present invention provides a mouse with an integrated keyboard wherein the same can be utilized for providing convenience for the user when entering data.

It is therefore an object of the present invention to provide a new and improved mouse with an integrated keyboard that has all of the advantages of the prior art and none of the disadvantages.

Accordingly, one embodiment of the present invention is a computer keyboard mouse system. The system includes a housing, an integral motion sensing relay device, at least two pointer select buttons, and a data entry portion. The housing includes a first top portion and a second top portion. The integral motion sensing relay device is integrated within the housing. The motion sensing relay device inputs graphical location data to a graphical interface. The pointer select buttons are disposed on the first top portion of the housing. The pointer select button is operative for selecting graphical objects on the graphical interface. A data entry portion is disposed on the second top portion of the housing. The data entry portion includes a plurality of keys, wherein the data entry portion is operative for inputting data to the graphical interface.

It is another object of the present invention to provide computer keyboard mouse system including a mode key. The mode key allows a user to switch between entering numbers and entering text.

It is another object of the present invention to provide computer keyboard mouse system including a plurality of keys including a backspace key, delete key, and a keyboard. The backspace key and the delete key may be adjacent to each other and positioned above the keyboard. The keyboard may have four rows of three keys corresponding to a number set and a set of letters. The keyboard may correspond to a number set from 0-9 and letters A-Z.

Another object of the present invention is to provide computer keyboard mouse system with a keyboard including numbers 0-9, a space key, and an enter key. In one embodiment, three letters may be disposed on number keys 2-9. The enter key and space key may be positioned at the bottom of the number set, separated by the number 0.

Yet another object of the present invention is to provide a computer keyboard mouse system with a keyboard the has four rows of three keys corresponding to a number set from 0-9 and letters A-Z.

Another object of the present invention is to provide computer keyboard mouse system with including one or more hot keys. The hot keys are disposed on a side of the housing. The hot keys may be assigned a desired function by the user.

It is another object of the present invention is to provide computer keyboard mouse system further including a scroll wheel. The scroll wheel may be located between the two pointer select buttons. The scroll wheel may be arranged along the line of connection between the two pointer select buttons such that a user can easily operate the scroll wheels with an index finger.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead view of the computer keyboard mouse system according to one embodiment of the present invention.

FIG. 2 shows a perspective view of the computer keyboard mouse system according to one embodiment of the present invention.

FIG. 3A shows a perspective view of a wired embodiment of the present invention.

FIG. 3B shows a perspective view of a wireless embodiment of the present invention.

FIG. 4 shows a block diagram of the computer keyboard mouse system coupled to a computer system according to one embodiment of the present invention.

### DETAILED DESCRIPTION OF THE INVENTION

Reference is made herein to the attached drawings. Like reference numerals are used throughout the drawings to depict like or similar elements of the computer keyboard mouse system. For the purposes of presenting a brief and clear description of the present invention, the preferred embodiment will be discussed as used for computers, tablets and other potable electronic devices. The figures are intended for representative purposes only and should not be considered to be limiting in any respect.

A computer mouse having a keyboard and additional buttons thereon is provided to help users increase efficiency and save time while entering data or performing other tasks on a computer or similar electronic device.

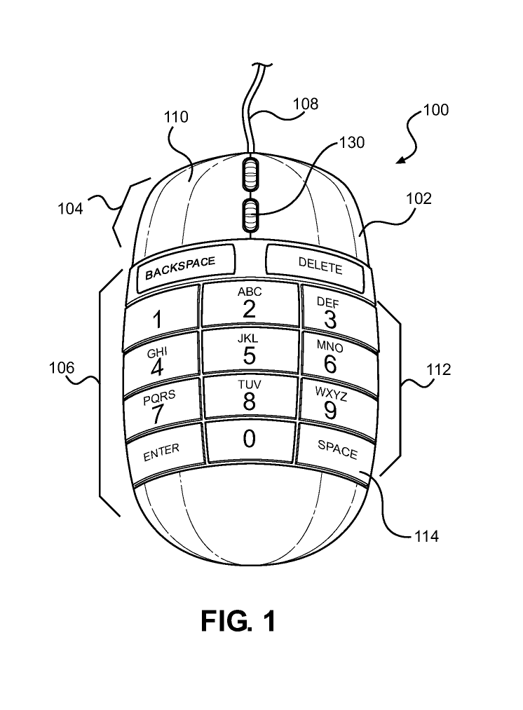

Referring now to FIG. 1, there is shown an overhead view of the computer keyboard mouse system according to one embodiment of the present invention. The computer keyboard mouse system 100 may include at least a housing 102, a motion sensing relay device 108, at least two pointer select buttons 110, and a data entry portion 112.

The housing includes a first top portion 104 and a second top portion 106. The motion sensing relay device 108 may be integrally attached to the housing 102. The motion sensing relay device 108 inputs graphical location data to a graphical interface. The graphical location data relates the location of the computer keyboard mouse system with respect to a computer interface. The at least two pointer select buttons 110 may be disposed on the first top portion 104 of the housing 102. The pointer select buttons 110 are operative for selecting graphical objects on the graphical interface. The data entry portion 112 may be disposed on the second top portion 106 of the housing 102. The data entry portion 112 may include a plurality of keys 114. The data entry portion 112 is operative for inputting data to the graphical interface.

According to one embodiment of the present invention, the computer mouse keyboard mouse system of the present invention includes one or more pointer select buttons 110 disposed side-by-side on the first top portion 104 of the mouse, similarly to a traditional mouse, and includes one or more scroll wheels 130. In a preferred embodiment of the present invention, scroll wheels 130 are arranged along the line of connection between the two pointer select buttons 110 such that a user can easily operate the scroll wheels 130 with an index finger.

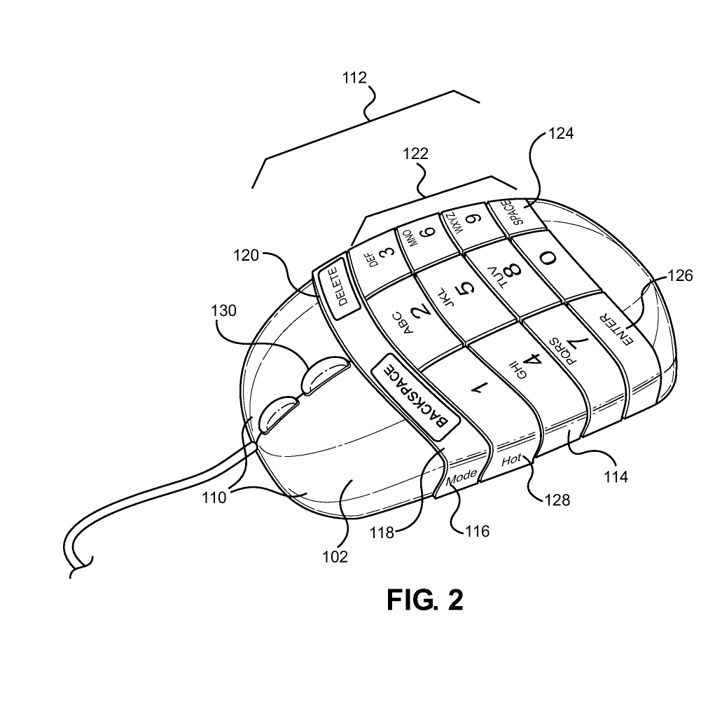

Now referring to FIG. 2, there is shown a perspective view of the computer keyboard mouse system according to one embodiment of the present invention. The computer keyboard mouse system may include a data entry portion 112 on the second top portion of the housing 102. The data entry portion 112 includes a plurality of keys 114 for data entry from the mouse.

According to another embodiment of the present invention, the plurality of keys 114 include a backspace key 118, a delete key 120, and a keyboard 122. The keyboard 122 has four rows of three keys corresponding to a number set and a set of letters. The backspace key 118 and the delete key 120 may be adjacent to each other and positioned above the keyboard 122. The keyboard 122 may include number set 0-9, a space key 124, and an enter key 126. The enter key 126 and space key 124 may be positioned at the bottom of the number set. The enter key 126 and the space key 124 are separated by the numeral “0”. The keyboard 122 may correspond to both a number set from 0-9 and letters A-Z. Three letters may be disposed on each of the number keys 2-9. This configuration is similar to many telephone number sets. According to another embodiment of the present invention, the computer keyboard mouse system further includes a mode key 116. The mode key 116 allows a user to switch between entering numbers or entering text.

According to yet another embodiment of the present invention, the computer keyboard mouse system may further include one or more hot keys 128. The hot keys 128 may be disposed on a side of the housing 102. The hot keys 128 are assigned a function which allows a user to select specific actions on a device. According to still yet another embodiment of the present invention, the computer keyboard mouse system may further include a scroll wheel 130 between the at least two pointer select buttons 110.

According another example embodiment, the computer keyboard mouse system further includes backspace and delete keys arranged side-by-side and adjacent to the pointer select buttons. The computer mouse includes a keyboard having four rows of three buttons each corresponding to a number set and a set of letters, similar to a telephone keypad. In addition to numbers 0-9, the keyboard includes an enter key 126 and a space key 124. The computer mouse includes a mode button 116 that allows the user to selectively switch the operation of the keyboard disposed thereon such that the user can either enter numbers or letters by pressing the keys. In this way, the keyboard allows a user to enter numbers or other data without having to switch from operating the mouse to the computer's keyboard. Lastly, the computer mouse of the present invention includes one or more hot keys 128 disposed on the sides of the mouse that can be assigned various functions as desired by the user.

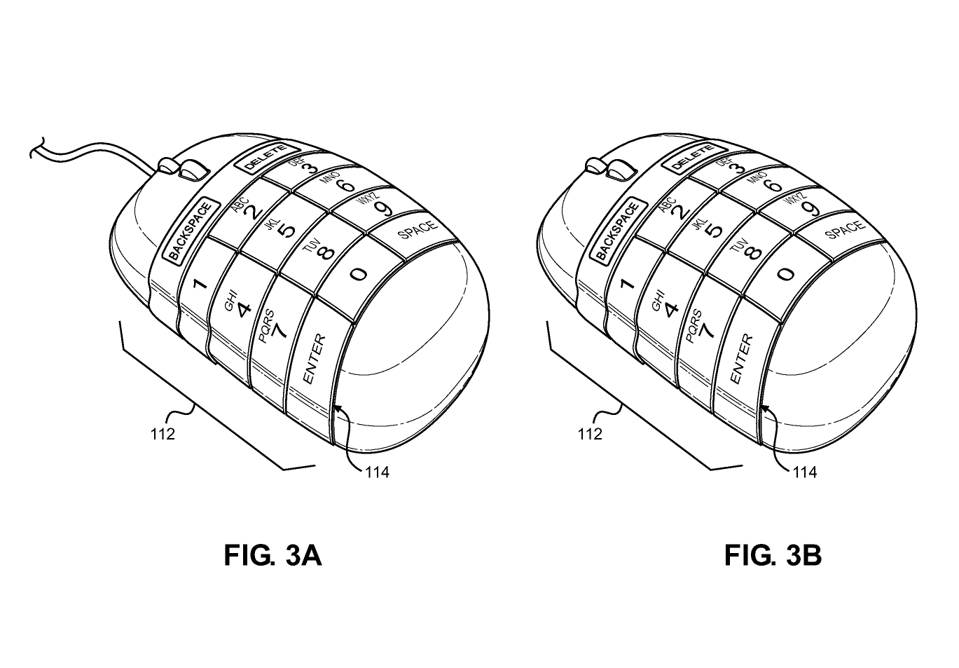

Referring now to FIGS. 3A and 3B, there are shown views of wired and wireless embodiments of the computer keyboard mouse system of the present invention wherein the keys 114 thereon are able to be illuminated. The keyboard 112 and other buttons on the mouse may have a means for illuminating the keys 114 or buttons to allow the user to more easily see and use the keyboard and buttons in low light. Further, the mouse can be provided in corded or wireless versions to suit user preference. The computer mouse of the present invention has been described in a preferred embodiment, and other arrangements of keys or buttons on the mouse are contemplated. Furthermore, additional buttons may be included on the mouse to improve its functionality.

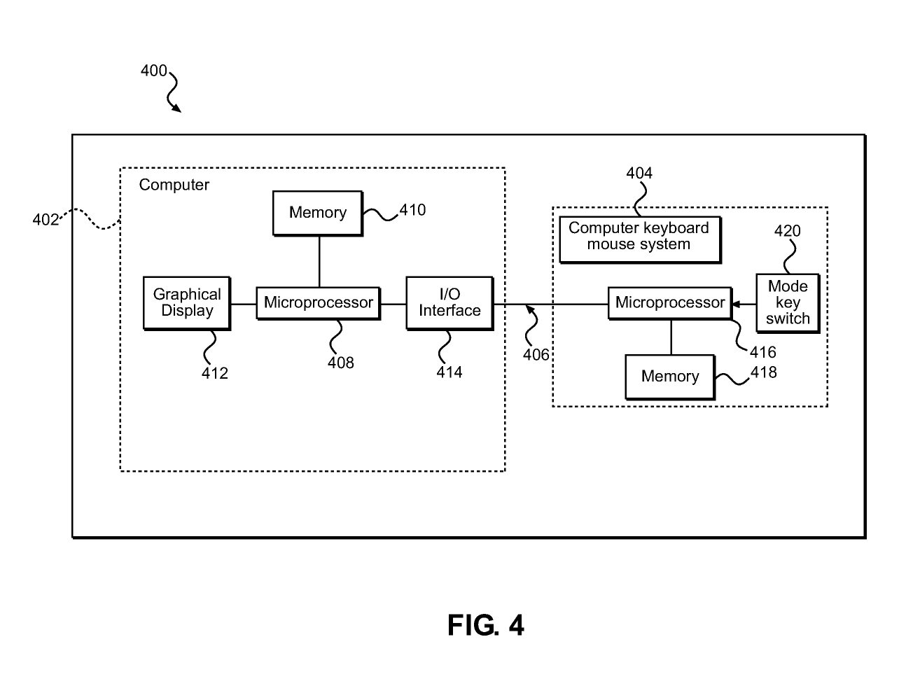

Referring now to FIG. 4, there is shown block diagram of the computer keyboard mouse system coupled to a computer system. The system 400 includes a portable electronic device 402, to which the computer keyboard mouse system 404 is connected via a cable 406. The portable electronic device 402 includes a microprocessor 408 operatively connected to a memory 410, a graphical display 412, and an I/O interface 414. The computer keyboard mouse system 404 includes a microprocessor 416, which is electrically connected to the microprocessor 408 via the cable 406 and I/O interface 414. The microprocessor 416 is also connected to a memory device 418 in which is stored logic instructions for execution by the microprocessor 416. The computer keyboard mouse system 404 further includes a mode key switch 420 for providing a signal to the microprocessor 416 indicative of the corresponding data entry preference.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A computer keyboard mouse system, comprising:
a housing comprising a first top portion and a second top portion;
a motion sensing relay device integrally attached to the housing, the motion sensing relay device adapted to input graphical location data to a graphical interface;
at least two pointer select buttons disposed on the first top portion of the housing, wherein the at least two pointer select buttons are operative for selecting a graphical object on the graphical interface; and
a data entry portion disposed on the second top portion of the housing, the data entry portion comprising a plurality of keys, wherein the data entry portion is operative for inputting data to the graphical interface.

2. The computer keyboard mouse system of claim 1, further comprising a mode key.

3. The computer keyboard mouse system of claim 2, wherein the mode key allows a user to switch between entering numbers and entering text.

4. The computer keyboard mouse system of claim 1, wherein the plurality of keys comprise a backspace key, a delete key, and a keyboard, wherein the keyboard has four rows of three keys corresponding to a number set and a set of letters.

5. The computer keyboard mouse system of claim 4, wherein the backspace key and the delete key are adjacent to each other and positioned above the keyboard.

6. The computer keyboard mouse system of claim 4, wherein the keyboard comprises a number set 0-9, a space key, and an enter key.

7. The computer keyboard mouse system of claim 6, wherein the enter key and space key are positioned at a bottom of the number set.

8. The computer keyboard mouse system of claim 4, wherein the keyboard corresponds to a number set from 0-9 and letters A-Z.

9. The computer keyboard mouse system of claim 8, wherein three letters are disposed on number keys 2-9.

10. The computer keyboard mouse system of claim 1, further comprising one or more hot keys, wherein the hot keys are disposed on a side of the housing.

11. The computer keyboard mouse system of claim 10, wherein the hot keys are assigned a function.

12. The computer keyboard mouse system of claim 1, further comprising a scroll wheel between the at least two pointer select buttons.
